(19) United States
(12) Patent Application Publication
(10) Pub. No.: US 2023/0152451 A1
(43) Pub. Date: May 18, 2023

(54) SYSTEM FOR SIMULTANEOUSLY MEASURING 3DOF LGEs BY LASER AND METHOD THEREFOR

(71) Applicant: BEIJING JIAOTONG UNIVERSITY, Beijing (CN)

(72) Inventors: Qibo FENG, Beijing (CN); Fajia ZHENG, Beijing (CN); Peizhi JIA, Beijing (CN); Jing YANG, Beijing (CN); Bin ZHANG, Beijing (CN); Jiakun LI, Beijing (CN)

(21) Appl. No.: 17/980,679

(22) Filed: Nov. 4, 2022

(30) Foreign Application Priority Data
Nov. 12, 2021 (CN) 202111338714.X

(51) Int. Cl. G01S 17/08; G01S 7/481

(52) U.S. Cl. CPC G01S 17/08; G01S 7/4814; G01S 7/4816

(57) ABSTRACT

A system for simultaneously measuring 3DOF LGEs by a laser and a method therefor, including a measuring unit and a target mirror unit, the measuring unit includes a laser emitting module, a polarizing beam splitter, a fixed reflector, a first photodetector, and an interference length measuring module; the target mirror unit includes a reflector; the laser emitting module generates an emitting light L1, the polarizing beam splitter is used for 1) “beam splitting” comprising splitting the emitting light L1 into a measuring light L11 and a reference light L12, the measuring light L11 is incident on the target mirror unit and is reflected back by the target mirror unit, so as to return to the measuring unit with a 3DOF LGEs signal; and 2) “beam combining” making the measuring light L11 and the reference light L12 superposed with each other at a spatial position, so as to form a combined beam L3; by measuring a position, frequency and phase drifts of the light L3, the 3DOF LGEs of a space object moving linearly along linear axes can be rapidly measured simultaneously; or a longtime monitoring 3DOF linear position drifts of two objects in space can be realized.

### FIELD OF THE INVENTION

The present invention relates to a technical field of optical precision measurement, in particular, the present invention relates to a system for simultaneously measuring 3DOF (degrees-of-freedom) LGEs by a laser; and a method for simultaneously measuring 3DOF LGEs.

### BACKGROUND

With development of precision manufacturing, machining and assembling technologies, an accuracy for measuring 3DOF LGEs of an object in motion or drifts of 3DOF LGEs of an object at rest needs to be higher and higher.

In prior art, a laser interferometer is the most often used tool to measure the 3DOF LGEs. However, the laser interferometer works only for a single parameter. Only one error component can be measured each time of installation and adjustment. In each measurement process, different types of measuring accessories and new adjustment of the interferometer are required, making a long time for each measurement, and the measurement accuracy is greatly sacrificed by environmental fluctuation. Therefore, it is necessary to develop a strategy for simultaneously measuring 3DOF LGEs.

In the prior art, a system for simultaneously measuring 3DOF LGEs has such drawbacks that its optical path is too complex, and multiple detectors are used to measure different errors, which increases a cost and complexity of the system, and increases the instability of the optical path caused by circuit heat dissipation, thus introducing extra possible measurement errors.

### SUMMARY OF THE INVENTION

The present invention provides some embodiments of a system and a method for simultaneously measuring 3DOF LGEs by a laser, so as to realize simultaneous and rapid measurement of the 3DOF LGEs of a 3D object moving linearly along any linear axis.

In order to achieve the above object, the present invention has the following technical solutions.

According to one aspect of the present invention, there is provided a system for simultaneously measuring 3DOF LGEs by a laser, comprising a measuring unit and a target mirror unit, the measuring unit includes a laser emitting module, a polarizing beam splitter, a fixed reflector, a first photodetector, and an interference length measuring module; the target mirror unit includes a reflector;

the laser emitting module is used to generate an emergent light or emitting light L1;

the polarizing beam splitter is used for: 1) beam splitting: splitting the emergent light L1 into a measuring light L11 and a reference light L12, the measuring light L11 is hitting on or passing through the target mirror unit and is reflected back by the target mirror unit, and then returns to the measuring unit with a 3DOF LGEs signal, while the reference light L12 only propagates inside the measuring unit; 2) beam combining: according to one of two polarizing directions, transmitting or reflecting the reference light L12 that hits on or passes through the polarizing beam splitter again and the measuring light L11 that is reflected back 180° toward its original direction by the target mirror unit, so that the two beams of the measuring light L11 and the reference light L12 are superposed with each other in a spatial position, so as to form a combined light L3;

the fixed reflector is used for backward reflecting the reference light L12 propagating only inside the measuring unit, so as to return the reference light L12 to the polarizing beam splitter;

the first photodetector is used to receive the combined light L3 including the reference light L12 and the measuring light L11, so as to realize a simultaneous measurement of linear geometric errors along the X, Y and Z axes. Specifically, 1) according to a spot offset of the measuring light L11 on the first photodetector, a relative straightness errors between the target mirror unit and the measuring unit along Y or Z axis is calculated; 2) coordinating with the interference length measuring module, a relative position error between the target mirror unit and the measuring unit along X-axis is obtained;

the reflector in the target mirror unit is used to reflect the measuring light L11 backward, and return the measuring light L11 to the polarizing beam splitter, so as to realize: 1) changing spatial positions of the measuring light L11 in Y and Z directions, so that a spatial position offset becomes twice relative displacements between the reflector of the target mirror unit and the measuring unit along the Y and Z axes; 2) changing the optical path and frequency of the measuring light L11, to make a drift of the optical path and frequency be proportional to relative displacement between the reflector of the target mirror unit and the measuring unit along X-axis.

Preferably, when a single frequency is applied, the laser emitting module emits a single frequency laser, and the interference length measuring module includes a first polarizer, a first non-polarizing beam splitter, a phase retarder, and a second photodetector;

the first polarizer is arranged in the emitting direction of the combined light L3, and the polarizing axis direction or light transmitting axial direction of the first polarizer is adjusted, so that the reference light L12 and the measuring light L11 interfere with each other after the combined light L3 hits on or passes through the first polarizer;

the first non-polarizing beam splitter is arranged between the first polarizer and the first photodetector, and is used to split the combined beam L3 that has been interfered, in which one beam L31 is received by the first photodetector, while the other beam L32 is received by the second photodetector, and light intensities of interference spots on the first photodetector and the second photodetector are named as I₁, and I₂, respectively;

the phase retarder is arranged in front of the first photodetector or the second photodetector, so as to make a phase difference 90° of the interference spot signals I₁ and I₂ detected by the two photodetectors, then calculate the phase difference φ(Δx) between the reference light L12 and the measuring light L11, and calculate the relative displacement Δx between the target mirror unit and the measuring unit along X-axis according to the phase difference.

Preferably, when a single frequency laser measurement is applied, the laser emitting module emits a single frequency laser. The polarizing beam splitter is replaced with a second non-polarizing beam splitter. The interference length measuring module includes a first polarizer, a first non-polarizing beam splitter, a phase delay, and a second photodetector;

the second non-polarizing beam splitter is used for: 1) beam splitting: splitting the emergent light L1 into a measuring light L11 and a reference light L12, in which the measuring light L11 is hitting on or passing through the target mirror unit and is reflected back by the target mirror unit, and returns to the measuring unit with a 3DOF LGEs signal, while the reference light L12 only propagates inside the measuring unit; 2) beam combining: transmitting and reflecting the reference light L12 that hits on or passes through the non-polarizing beam splitter again and the measuring light L11 reflected by the target mirror unit, so that the two beams are superposed with each other in a spatial position, so as to form the combined beam L3, and the combined beam L3 is a superimposed beam of the two beams of the reference light L12 transmitted through the non-polarizing beam splitter and the measuring light L11 reflected by the non-polarizing beam splitter, or a superimposed beams of the two beams of the reference light L12 reflected by the non-polarizing beam splitter and the measuring light L11 transmitted through the non-polarizing beam splitter;

the first polarizer is arranged in an emitting direction of the combined light L3, and the polarizing axis direction of the first polarizer is adjusted, so that the reference light L12 and the measuring light L11 interfere with each other after the combined light L3 hits on or passes through the first polarizer;

the first non-polarizing beam splitter is arranged between the second non-polarizing beam splitter and the first photodetector, so as to split the combined beam L3 that has been interfered, in which one beam L31 is received by the first photodetector, while the other beam L32 is received by the second photodetector, and light intensities of interference spots on the first photodetector and the second photodetector are indicated as I₁ and I₂, respectively;

the phase retarder is arranged in front of the first photodetector or the second photodetector, and is used to make a phase difference 90° of the interference spot signals I₁ and I₂ detected by the two photodetectors, then a phase difference φ(Δx) between the reference light L12 and the measuring light L11 can be calculated, and a relative displacement Δx between the target mirror unit and the measuring unit along X-axis can be calculated according to the phase difference.

Preferably, when dual frequency laser measurement is applied, the laser emitting module emits a dual frequency laser light with a certain frequency difference and different polarization directions;

the interference length measuring module comprises a third non-polarizing beam splitter, a first polarization detector, a second polarization detector, and a third photodetector;

the third non-polarizing beam splitter is disposed between the laser emitting module and the polarizing beam splitter, so that the light L1 emitted by the laser emitting module is split by the third non-polarizing beam splitter, so as to form another laser beam L2;

the first polarizer is arranged in an emitting direction of a combined light with the reference light L12 and the measuring light L11 reflected by the target mirror and hitting on or passing through the polarizing beam splitter, and a polarizing axis direction of the first polarizer is adjusted, so that the combined light L3 with the light L12 and the light L11 hits on or passes through the first polarizer, then the reference light L12 and the measuring light L11 interfere with each other, and an interference spot is received by the first photodetector, as a length measuring signal for a heterodyne interferometry;

the second polarizer is arranged between the non-polarizing beam splitter and the third photodetector; by adjusting a polarizing axis direction of the second polarizer, the laser light L2 interferes after hitting on or passing through the third polarizer, and an interference spot is received by the third photodetector as a length measuring reference signal for the heterodyne interference;

the polarizer is used to determine a relative displacement of the target mirror unit and the measuring unit along X axis according to the reference signal and the measurement signal.

Preferably, when a multi wavelength measurement is applied, the laser emitting module includes a multi wavelength laser light source and a heterodyne frequency generating module, the interference length measuring module includes 1st to Nth bandpass filters and 1st to Nth phase detectors, N is a natural number greater than or equal to 3, and the polarizing beam splitter is replaced by a second non-polarizing beam splitter;

the multi wavelength laser light source emits multi wavelength laser lights λ₁, λ₂, λ₃, . . . , A_{N} with frequencies v₁, v₂, v₃ . . . v_{N}; after passing through the heterodyne frequency generating module, the frequencies of the multi wavelength laser become v₁+f₁, v₂+f₂, v₃+f₃, . . . , v_{N}+f_{N}, the multi wavelength laser light is the emergent light L1, the second non-polarizing beam splitter is used for: 1) beam splitting: splitting the emergent light L1 into a measuring light L11 and a reference light L12, the measuring light L11 is hitting on or passing through the target mirror unit, and then is reflected back by the target mirror unit; the light L11 carries a 3DOF LGEs signal and returns to the measuring unit as a measuring light; the reference light L12 only propagates within the measuring unit; 2) beam combining: the reference light L12 that hits on or passes through the second non-polarizing beam splitter again and the measuring light L11 reflected by the target mirror unit are transmitted and reflected, so that the two beams are superposed with each other in a spatial position, so as to form a combined beam L3;

the light L3 interferes on the first photodetector, and the obtained heterodyne interference signal spectrum only contains components f₁, f₂, f₃, . . . , f_{N};

after the 1st to Nth bandpass filters separate the components f₁, f₂, f₃, . . . , f_{N}, the length measuring phase information φ₁, φ₂, φ₃, . . . , φ_{N} corresponding to each wavelength is measured by the 1st to Nth phase detectors; taking n pairs of the length measuring phase data (2≤n≤N−1, n is a natural number) to form a beat signal, and calculating the relative displacement Δx between the target mirror unit and the measuring unit along X-axis according to n pairs of wavelength and n pairs of phase difference.

Preferably, the fixed reflector is any one of a pyramid prism, a cat eye mirror, an angular cube retroreflector composed of three mutually perpendicular reflecting surfaces, a right angle prism, and a mirror group composed of two plane mirrors; and the target mirror unit reflector is any one of a pyramid prism, a cat eye mirror, and an angular cube retroreflector composed of three mutually perpendicular reflecting surfaces.

Preferably, the first photodetector, the second photodetector, the fourth photodetector, and the fifth photodetector are any one of QD (Four-quadrant photodetector), PSD (Position Sensitive Detector), CCD (Charge-coupled Component) and CMOS (Complementary Metal Axide Semiconductor); and a relative straightness error between the target mirror unit and the measuring unit along Y-axis and/or Z-axis is calculated according to the spot offset on any one of the four photodetectors; while the third photodetector is any one of QD, PSD, CCD, CMOS and pin.

According to another aspect of the present invention, there is provided a method for simultaneously measuring 3DOF LGEs with a laser, comprising:

Step 1) measuring a straightness error along Y-axis and/or Z-axis based on laser collimation principle

Step 1.1) when a light L1 emitted by a laser emitting module hits on or passes through a polarizing beam splitter, it is divided into a measuring light L11 and a reference light L12;

Step 1.2) after the measuring light L11 is emitted from the measuring unit, it is hitting on or passing through the target mirror unit; after being reflected back 180° toward its original direction by a reflector of the target mirror unit, a spatial position of the light L11 drifts with a relative straightness error between the target mirror unit and the measuring unit along Y-axis and/or Z-axis; the light L11 carries the two-dimensional straightness error information back to the measuring unit, and the light L11 hits on or passes through the polarizing beam splitter again;

Step 1.3) after the reference light L12 is reflected back 180° toward its original direction by a fixed reflector, it hits on or passes through the polarizing beam splitter again, then is combined with the light L11 hitting on or passing through the polarizing beam splitter again in step 1.2), so as to form a combined light L3, and is received by the first photodetector;

Step 1.4) an initial spot position of the combined beam is measured by the first photodetector;

Step 1.5) according to a real-time spot position of the combined beam on the first photodetector, comparing the real-time spot position with the initial spot position of the combined beam, it is obtained a spot offset amount of the combined beam; since the spot offset of the combined beam is only caused by a position drift of the measuring light L11, a relative straightness error between the target mirror unit and the measuring unit along Y-axis and/or Z-axis is calculated according to the spot offset of the combined beam;

Step 2) measuring a position error along X-axis based on laser interference

Step 2.1) after the reference light L12 in Step 1.1) is reflected back 180° toward its original direction by a fixed reflector of the measuring unit, its polarization state, frequency and phase are not changed, so the light L12 is used as a reference light of the interference length measuring signal;

Step 2.2) the frequency and phase of the light L11 in Step 1.2) drift with a relative displacement between the target mirror unit and the measuring unit along X-axis, and the light L11 carries the relative straightness error information along X-axis and returns to the measuring unit as a measuring light of the heterodyne interference length measuring signal;

Step 2.3) after the reference light in Step 2.1) and the measuring light in step 2.2) hit on (pass through) the polarizing beam splitter, the two beams are superposed with each other in a spatial position; after passing through the interference length measuring module, a relative straightness error between the target mirror unit and the measuring unit along X-axis is calculated by the signals measured on the first photodetector.

Preferably, calculating the relative straightness error along Y-axis and/or Z-axis according to the spot offset of the combined beam comprises:

the initial position and the real-time position of the light L11's spot on the first photodetector are (yIₒ, zIₒ), (yIₜ, zIₜ), respectively, then the relative straightness errors between the target mirror unit and the measuring unit along Y-axis and/or Z-axis are Δy=2(y1ₜ−y1ₒ), Δz=2(z1ₜ−z1ₒ), respectively.

Preferably, when a single frequency length measurement is applied, measuring the position error along X-axis based on the laser interferometry comprises:

Step 1) the reference light L12 and the measuring light L11 are superposed with each other in a spatial position after hitting on or passing through the second non-polarizing beam splitter, so as to form a combined light L3; a polarizing axis direction of the first polarizer is adjusted, so that the combined light L3 interferes after hitting on or passing through the first polarizer;

Step 2) the interference light L3 is divided into lights L31 and L32 after hitting on or passing through the first non-polarizing beam splitter;

Step 3) after one of the beams L31 and L32 is delayed 90° by a phase retarder, they are received by the first photodetector and the second photodetector, respectively, and light intensities of the interference light spots on the first photodetector and the second photodetector are I₁ and I₂, respectively;

Step 4) by processing the I₁ and I₂, the phase difference between the reference light L12 and the measuring light L11 is φ(Δx), the number of light and dark changes of interference fringes caused by φ(Δx) is N(Δx), a laser wavelength emitting from a laser is λ, a relative displacement between the target mirror unit and the measuring unit along X-axis Δx=N(Δx)·λ/2.

Preferably, when a double frequency length measurement is applied, measuring the position error along X-axis based on the laser interference measurement comprises:

Step 1) the light L1 emitted from the laser emitting module includes two polarized lights with a certain frequency difference, the two frequencies are f₁ and f₂, respectively; and when the light L1 is split by the polarizing beam splitter, the frequency of the measuring light L11 is f₁, and the frequency of the reference light L12 is f₂;

Step 2) a relative displacement of the measuring light L11 between the target mirror unit and the measuring unit along X-axis is Δx; the frequency variation due to Doppler effect is f(Δx), the frequency of the measuring light L11 is f₁+f(Δx);

Step 3) setting a first polarizer in front of the first photodetector, adjusting a direction of the light transmitting axis of the first polarizer, so that the lights L12 and the light L11 interfere after hitting on or passing through the first polarizer, and the interference spot is received by the first photodetector as a measuring signal of the heterodyne interference length measurement, and a frequency of a measuring beat signal is fₘ=f₁+f(Δx)−f₂;

Step 4) when the emergent light L1 hits on or passes through the third non-polarizing beam splitter, it is split by the third non-polarizing beam splitter, so as to form another laser beam L2; the light L2 also contains two polarized lights with a certain frequency difference, and a polarizing axis direction of the second polarizer is adjusted, so that the light L2 interferes after hitting on or passing through the second polarizer; the interference spot is received by the second photodetector as a standard signal for the heterodyne interference length measurement; then the standard signal frequency is fₛ=f₁f₂;

Step 5) fₘ=f₁+f(Δx)−f₂, the frequency of the measuring beat signal obtained in Step 3), is subtracted by fₛ=f₁−f₂, the standard beat signal frequency obtained in Step 4), so as to obtain f(Δx)=fₘ−fₛ, the number of light and dark changes of interference fringes caused by f(Δx) is N(Δx), a laser wavelength emitting from a laser is λ, so a relative displacement between the target mirror unit and the measuring unit along X-axis is Δx=N(Δx)·λ/2.

Preferably, when measuring a multiple wavelength measurement is applied, measuring the position error along X-axis based on the laser interference comprises:

Step 1) a multi wavelength laser light source emits multi wavelength laser lights λ₁, λ₂, λ₃, . . . , λ_{N}; their frequencies are v₁, v₂, v₃, . . . , v_{N}; after passing through a heterodyne frequency generating module, the frequencies of the multi wavelength laser become v₁+f₁, v₂+f₂, v₃+f₃, v_{N}+f_{N}, the multi wavelength laser light is the emergent light L1;

Step 2) the light L1 emitted from the laser emitting module is divided into a measuring light L11 and a reference light L12 by the second non-polarizing beam splitter, and the measuring light L11 and the reference light L12 both contain multi wavelength laser lights v₁+f₁, v₂+f₂, v₃+f₃, v_{N}+f_{N};

Step 3) the measuring light L11 is emitted from the measuring unit to enter the target mirror unit, and is reflected back 180° toward its original direction by a reflector of the target mirror unit as the reflected back 180° toward its original direction light L11, the light L11 carries the straightness error information along X-axis and returns to the measuring unit as a measuring light of a heterodyne interference length measuring signal;

Step 4) after the reference light L12 is reflected back 180° toward its original direction by a fixed reflector of the measuring unit, it hits on or passes through the non-polarizing beam splitter, and then combines with the light L11, and a polarizing axis direction of the first polarizer is adjusted, so that the reference light L12 and the measuring light L11 interfere with each other on the first photodetector;

Step 5) the first photodetector detects components f₁, f₂, f₃, . . . , f_{N} of the heterodyne interference signal spectrum, and the 1st to Nth band-pass filters separate the components f₁, f₂, f₃, . . . , f_{N}, and the 1st to Nth phase detectors measure the length measuring phase information φ₁, φ₂, φ₃, . . . , φ_{N} corresponding to each wavelength; taking n pairs of a beat signal composed of a wavelength and a phase difference, 2≤n≤N−1, n is a natural number, a relative displacement Δx between the target mirror unit and the measuring unit along X-axis is calculated according to the n pairs of wavelength and n pairs of phase difference.

It can be seen from the above technical solutions provided by the embodiments of the present invention that the system and method for simultaneously measuring 3DOF LGEs by a laser can realize simultaneous and rapid measurement of 3DOF LGEs of a 3D object moving linearly along any linear axis, so that it can long time monitor 3DOF linear relative position drifting between two objects in a space.

Additional aspects and advantages of the present invention will be given in the following description, which will become apparent from the following description, or will be learned from the embodiments of the present invention.

### BRIEF DESCRIPTION OF DRAWINGS

In order to more clearly explain the technical solutions of the embodiments of the present invention, the following will briefly introduce drawings that need to be used in the description of the embodiments. It is obvious that the drawings in the following description show only some embodiments of the present invention. For those skilled in the art, other embodiments could also be obtained according to these drawings without inventive efforts.

FIG. 1 is a structural view of a system for simultaneously measuring 3DOF LGEs (linear-geometric-errors) by a single frequency laser according to one embodiment of the present invention.

FIG. 2 is a structural view of an interference length measuring module of a single frequency laser with dual channels according to one embodiment of the present invention.

FIG. 3 is a structural view of an interference length measuring module of a single frequency laser with four channels according to one embodiment of the present invention.

FIG. 4 is a structural view of a system for simultaneously measuring 3DOF LGEs by a single frequency laser according to one embodiment of the present invention.

FIG. 5 is a structural view of a system for simultaneously measuring 3DOF LGEs by a single frequency laser according to the other embodiment of the present invention.

FIG. 6 is a structural view of a system for simultaneously measuring 3DOF LGEs by a single frequency laser according to another embodiment of the present invention.

FIG. 7 is a structural view of a system for simultaneously measuring 3DOF LGEs by a dual frequency laser according to another embodiment of the present invention.

FIG. 8 is a structural view of a system for simultaneously measuring 3DOF LGEs by a dual frequency laser according to the other embodiment of the present invention.

FIG. 9 is a structural view of a system for simultaneously measuring 3DOF LGEs by a dual frequency laser according to another embodiment of the present invention.

FIG. 10 is a structural view of a system for simultaneously measuring 3DOF LGEs by a multi wavelength laser according to one embodiment of the present invention.

### BEST MODES FOR CARRYING OUT THE INVENTION

Embodiments of the present invention will be described in detail below. In the embodiments shown in the drawings, the same or similar reference numerals indicate the same or similar elements having the same or similar functions. The embodiments described by referring to the accompanying drawings are exemplary and are only used to explain the present invention, but cannot be interpreted as limiting the present invention.

It can be understood by those skilled in the art that a singular form “a”, “one”, “said” and “the” used herein may also include plural parts, unless it is specifically stated. It should be further understood that the word “including” or “comprising” used in the description of the present invention refers to have those mentioned features, integers, steps, operations, elements, and/or components, but does not exclude having one or more other features, integers, steps, operations, elements, components and/or combinations thereof. It should be understood that when an element is “connected” or “coupled” to another element, it may be directly connected or coupled to other elements, or there may be intermediate elements. In addition, the words “connecting” or “coupling” used herein may include wireless connecting or coupling. The term “and/or” used herein includes any unit and all combinations of one or more listed items.

Unless otherwise defined, all terms (including technical terms and scientific terms) used herein have the same meaning as those generally understood by those skilled in the art. It should also be understood that terms defined in a general dictionary should be understood to have a meaning consistent with the prior art, and will not be interpreted literally unless defined as herein.

In order to facilitate understanding of those embodiments of the present invention, several specific embodiments will be further explained together with the accompanying drawings, and each embodiment does not constitute a limitation of the present invention.

The embodiments will corroborate again and again that the present invention can realize simultaneously measuring 3DOF LGEs with optical components and detectors as less as possible.

### Embodiment 1

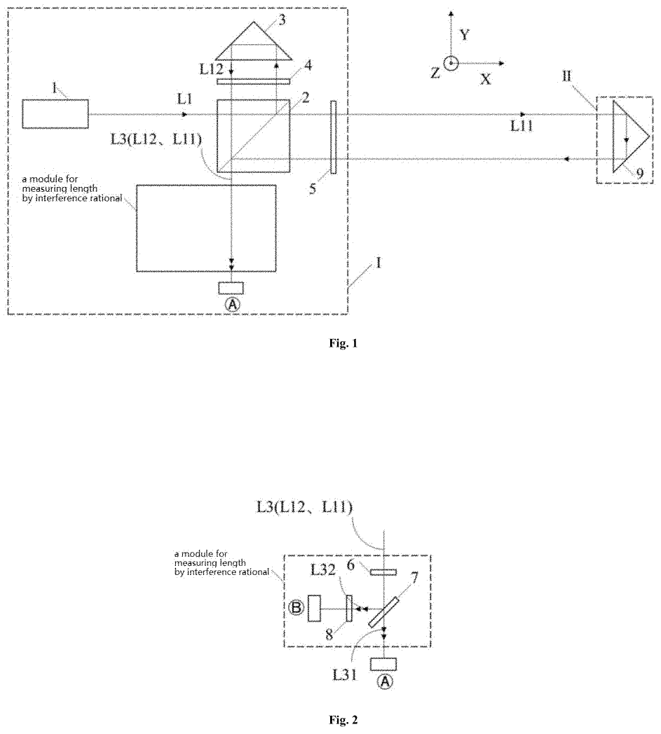

FIG. 1 is a structural view of a system for simultaneously measuring 3DOF LGEs by a single frequency laser according to an embodiment of the present invention. FIG. 2 is a structural view of an interference length measuring module with a single frequency and dual channels according to an embodiment of the present invention. As shown in FIG. 1, according to one aspect of the present invention, there is provided a system for simultaneously measuring 3DOF LGEs by a laser, comprising a measuring unit I and a target mirror unit II.

The measuring unit I includes a single frequency laser 1, a polarizing beam splitter 2, a fixed pyramid prism 3, a first quarter-wave plate 4, a second quarter-wave plate 5, a first photodetector (A) and an interference length measuring module with a single frequency and dual channels. The single frequency laser 1 constitutes a laser emitting module. As shown in FIG. 2, the interference length measuring module includes a first polarizer 6, a first non-polarizing beam splitter 7, a half-wave plate 8, and a second photodetector (B).

The target mirror unit II includes a moving pyramid prism 9.

In the measuring unit I,

the single frequency laser 1 is used to generate an emergent light L1;

the polarizing beam splitter 2 is used for: 1) beam splitting: the emergent light L1 is divided into a transmitted light recorded as a measuring light L11, and a reflected light recorded as a reference light L12, the measuring light L11 is hitting on or passing through the target mirror unit II, and is reflected back by the moving pyramid prism 9 of the target mirror unit II, and then is returned to the measuring unit I with a 3DOF LGEs signal; the reference light L12 only propagates within the measuring unit I; 2) beam combining: the reference light L12 that will hit on (pass through) the polarizing beam splitter 2 again is transmitted, and the measuring light L11 reflected back by the target mirror unit II is further reflected, so that the two beams of the measuring light L11 and the reference light L12 are superposed with each other in a spatial position, which is denoted as L3;

the fixed pyramid prism 3 is used for backward reflecting the reference light L12 propagating only inside the measuring unit I, so as to return the reference light L12 to the polarizing beam splitter 2;

the first quarter-wave plate 4 is used to change a polarization direction of the reference light L12, the reference light L12 is reflected by the polarizing beam splitter 2, i.e., transmitting and hitting on or passing through the first quarter-wave plate 4, being reflected backward by the fixed pyramid prism 3, transmitting the first quarter-wave plate 4 again, then hitting on or passing through the polarizing beam splitter 2 again. While the light L12 used to be reflected by the polarizing beam splitter 2, the light L12 transmits the polarizing beam splitter 2 when it returns and hits on or passes through the polarizing beam splitter 2 again;

the second quarter-wave plate 5 is used to change a polarization direction of the linear error measuring light L11, so that the measuring light L11 is reflected by the polarizing beam splitter 2 when it hits on or passes through the polarizing beam splitter 2 again;

the first polarizer 6 is arranged between the polarizing beam splitter 2 and the first photodetector (A), and is used to make the combined light L3 interfere on the polarizer;

a first non-polarizing beam splitter 7 is arranged between the first polarizer 6 and the first photodetector (A) for splitting the interference light L3; one of the split interference light L3 is received by the first photodetector (A), while the other is received by the second photodetector (B); light intensities of interference spots on the first photodetector (A) and the second photodetector (B) are recorded as I₁ and I₂, respectively;

a half-wave plate 8 is arranged between the first non-polarizing beam splitter 7 and the second photodetector (B), so as to make a phase difference 90° of the interference spot signals I, and 12 detected by two detectors, calculate a phase difference φ(Δx) between the reference light L12 and the measuring light L11, and calculate a displacement Δx of the target mirror unit along X-axis according to the phase difference.

The first photodetector (A) is used to receive L31 to realize: 1) according to a spot offset of the light L11 in L31 on the first photodetector (A), calculating a straightness error of the target mirror unit II along Y-axis and/or Z-axis; 2) obtaining the interference spot signal I₁, and cooperating with the interference length measuring module to realize a position error measurement of the target mirror unit II along X-axis.

The second photodetector (B) is used to receive L32, obtain the interference spot signal 12, and realize a position error measurement of the target mirror unit II along X-axis, except for the I₁ measured by the first photodetector (A).

In the target mirror unit II,

the moving pyramid prism 9 is used to reflect the measuring light L11 backward and return the measuring light L11 to the polarizing beam splitter 2, so as to realize: 1) changing a spatial position of the measuring light L11 in Y direction and Z direction, and the amount of the spatial position offset is twice the amount of displacement of the pyramid prism 9 itself in the Y direction and the Z direction; 2) changing an optical path and frequency of the measuring light L11, and the amount of change in the optical path and frequency is proportional to a displacement amount of the pyramid prism 9 itself in X direction.

The embodiment 1 provides a method for simultaneously measuring 3DOF LGEs by a laser, comprising the following steps:

Step 1: measure the straightness error along Y-axis and/or Z-axis based on laser collimation principle

Step 1.1) when an emergent light L1 of a single frequency laser 1 hits on or passes through a polarizing beam splitter 2, it is divided into a measuring light L11 and a reference light L12, in which the measuring light L11 is transmitted through the polarizing beam splitter 2, the reference light L12 is reflected by the polarizing beam splitter 2, the measuring light L11 and the reference light L12 are both linearly polarized light, and polarization directions of the two lights are perpendicular to each other;

Step 1.2) the measuring light L11 hits on or passes through the second quarter-wave plate 5, the linearly polarized light is changed into a circularly polarized light, which is emitted from the measuring unit I and incident on the target mirror unit II; after being reflected back 180° toward its original direction by the pyramid prism 9 of the target mirror unit II, a spatial position of the light L11 changes with a straightness error of the target mirror unit II along Y-axis and/or Z-axis; the light L11 carries a two-dimensional straightness error information back to the measuring unit I and hits on or passes through the second quarter-wave plate 5 again, the light L11 changes from the circularly polarized light to a linearly polarized light, but a polarization direction at hitting on or passing through the second quarter-wave plate 5 again is rotated by 90° with respect to that when hitting on or passing through the second quarter-wave plate 5 the first time, so that the light L11 becomes reflected by the polarizing beam splitter 2 when it hits on or passes through the polarizing beam splitter 2 again;

Step 1.3) the reference light L12 hits on or passes through the first quarter-wave plate 4, the linearly polarized light is changed into a circularly polarized light, and is reflected back 180° toward its original direction by a fixed pyramid prism 3 and hits on or passes through the first quarter-wave plate 4 again, it changes from the circularly polarized light to a linearly polarized light, but a polarization direction at hitting on or passing through the first quarter-wave plate 4 again is rotated by 90° with respect to that for hitting on or passing through the first quarter-wave plate 4 for the first time, so that when reaching the polarizing beam splitter 2, the light L12 becomes transmitted through the polarizing beam splitter 2, and is combined with the light L11 reflected by the polarizing beam splitter in Step 1.2, so as to form the combined light L3; the light L3 is divided into two lights L31 and L32 after going over a first polarizer 6 and hitting on or passing through a first non-polarizing beam splitter 7, and the lights L31 and 32 are received by a first photodetector (A) and a second photodetector (B), respectively;

Step 1.4) recording an initial position (yIₒ, zIₒ) of the light L31 measured by the first photodetector (A), and the initial position is preferred located at the center of the first photodetector (A);

Step 1.5) according to a real-time position (y1ₜ, z1ₜ) of the light L31 on the first photodetector (A), comparing it with the initial position (yIₒ, zIₒ) of the light L31, so as to obtain an offset amount of a L31 spot position; the L31 spot position offset is only caused by a position drift of the measuring light L11, a straightness error of the target mirror unit along Y-axis and/or Z-axis is calculated according to the L31 spot position offset Δy=2(y1ₜ−y1ₒ), Δz=2(z1ₜ−z1ₒ); in Step 1.4 and Step 1.5, an offset amount of the light L32 spot position can also be measured by the second photodetector (B) to calculate a straightness error of the target mirror unit along Y-axis and/or Z-axis.

Step 2: measuring the position error along X-axis based on laser interference Step 2.1) after the reference light L12 in Step 1.1 is reflected back 180° toward its original direction by a fixed pyramid prism 3 of the measuring unit I, its polarization direction, frequency and phase are not changed, and the light L12 is used as a reference light of an interference length measurement signal;

Step 2.2) the frequency and phase of the light L11 in Step 1.2 change with a displacement of the target mirror unit II along X-axis, and the light L11 returns a straightness error information along X-axis to the measuring unit I as a measuring light signal for the heterodyne interference length measurement;

Step 2.3) adjusting a polarizing axis direction of a first polarizer 6, so that the combined light L3 in Step 1.3 interferes after hitting on or passing through the first polarizer 6;

Step 2.4) after the interference light L3 hits on or passes through the first non-polarizing beam splitter 7, it is divided into a transmitted light L31 and a reflected light L32;

Step 2.5) the transmitted light L31 is received by the first photodetector (A), its intensity of an interference spot light is I₁, and the reflected light L32 hitting on or passing through a half-wave plate 8 is received by the second photodetector (B), in which the phase is delayed by 90°, its intensity of the interference spot is 13;

Step 2.6) a phase difference between the reference light L12 and the measuring light L11 is φ(Δx), by processing I₁ and I₃, the number N(Δx) of light and dark changes of interference fringes caused by φ(Δx) is obtained; the emitting laser wavelength of the single frequency laser 1 is λ, the displacement of the target mirror unit II along X-axis is Δx=N(Δx)·λ/2.

In Step 2.5, the half-wave plate 8 can also be arranged before the first photodetector (A), so that the phrase of the transmitted light L31 can be delayed by 90° through the half-wave plate 8.

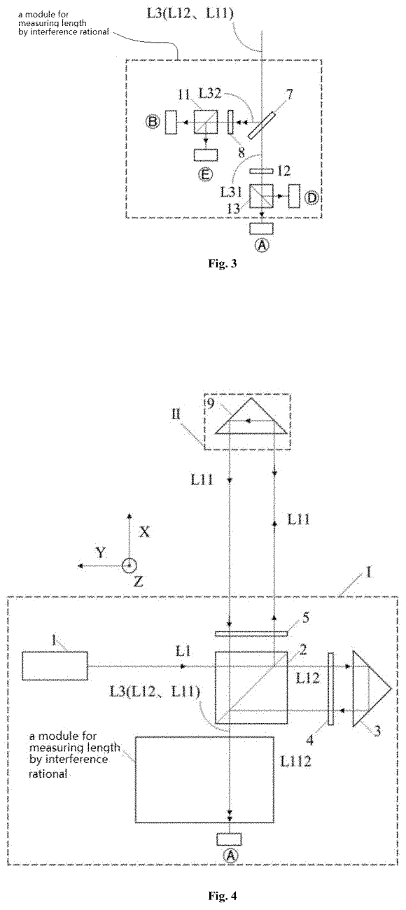

As shown in FIG. 3, this embodiment can also adopt a single frequency laser with four channels in an interference length measuring module, including a first non-polarizing beam splitter 7, a half-wave plate 8, a second polarizing beam splitter 11, a third quarter-wave plate 12, a third polarizing beam splitter 13, a second photodetector (B), a third photodetector (C), and a fourth photodetector (D).

The combined light L3 hits on or passes through the non-polarizing beam splitter 7, dividing into a transmitted light L31 and a reflected light L32.

The transmitted light L31 hits on or passes through the third quarter-wave plate 12, and is divided into lights L311 and L312. The transmitted light L311 is received by the first photodetector (A), its light intensity of interference spot is I₁. The reflected light L312 is received by the fourth photodetector (D), its light intensity of interference spot is 14; and a phase difference between I₁ and I₄ is 180°.

The reflected light L32 hits on or passes through the half-wave plate 8, with a phase delay of 90°, hits on or passes through the second polarizing beam splitter 11 and is split; the transmitted light L321 is received by the second photodetector (B), its light intensity of the interference spot is I₂. The reflected light L322 is received by the fifth photodetector (E), the light intensity of the interference spot is 15; and a phase difference between 12 and 15 is 180°;

The phases of I₁, I₂, I₄ and I₅ are different by 90° from one to next, and the phase difference between the reference light L12 and the measuring light L11 is φ(Δx), by processing I₁, I₂, I₄ and I₅, the number N(Δx) of light and dark changes of interference fringes caused by φ(Δx) is obtained; an emitting laser wavelength of the single frequency laser 1 is λ, a displacement of the target mirror unit II along X-axis is Δx=N(Δx)·λ/2; compared with the dual channel interference length measuring module, the four channel interference length measuring module can also judge a moving direction of the target mirror unit.

### Embodiment 2

FIG. 4 is a view of a system for simultaneously measuring 3DOF LGEs by a single frequency laser according to an embodiment of the present invention. As shown in FIG. 4, according to another one aspect of the present invention, there is provided a system for simultaneously measuring 3DOF LGEs by a single frequency laser, including a measuring unit I and a target mirror unit II.

The measuring unit I includes the same components as the measuring unit I in embodiment 1, and the target mirror unit II has the same components as the target mirror unit II in embodiment 1. The difference therebetween is in that when an emergent light L1 hits on or passes through the polarizing beam splitter 2, its reflected light is taken as a measuring light L11, and the target mirror unit II is arranged in a direction that the polarizing beam splitter 2 reflects the light L1, and its transmitted light is taken as a reference light L12, a fixed pyramid prism 3, and the first quarter-wave plate 4 are disposed in a direction in which the polarizing beam splitter 2 transmits the light L1. For convenience of description, a structure in which the transmitted light L1 used as the measuring light L11 in Embodiment 1 is referred to as a transmission sensitive structure, while a structure in which the reflected light L1 used as the measuring light L11 in this Embodiment 2 is referred to as a reflection sensitive structure.

In the measuring unit I,

the polarizing beam splitter 2 is used for: 1) beam splitting: the emergent light L1 is divided into a reflected light recorded as the measuring light L11, and a transmitted light recorded as the reference light L12, the measuring light L11 is hitting on or passing through the target mirror unit II, and is reflected back by a moving pyramid prism 9 of the target mirror unit II, and then returns to the measuring unit I with a 3DOF LGEs signal; the reference light L12 only propagates within the measuring unit I; 2) beam combining: the reference light L12 that hits on or passes through the polarizing beam splitter 2 again is transmitted, while the measuring light L11 is reflected back by the target mirror unit II, so that the two beams of the measuring light L11 and the reference light L12 are superposed with each other in a spatial position, which is denoted as a light L3;

a first quarter-wave plate 4 is used to change a polarization direction of the reference light L12, so that the reference light L12 is transmitted through the polarizing beam splitter 2, then hitting on or passing through the first quarter-wave plate 4, backward reflecting by a fixed pyramid prism 3, and transmitting the first quarter-wave plate 4 again; whenever the light L12 hints on the polarizing beam splitter 2 again, it becomes reflected by the polarizing beam splitter 2, that is, an original transmitted state is switched to the reflected state;

a second λ₄ wave plate 5 is used to change a polarization direction of a linear error measuring light L11, so that the measuring light L11 is transmitted through the polarizing beam splitter 2 when it meets the polarizing beam splitter 2 again.

The functions of other components are the same as those of Embodiment 1, and will not be described in detail again.

The target mirror unit II includes a moving pyramid prism 9, whose function is the same as that in Embodiment 1, and will not be described in detail again.

The present Embodiment 2 provides a method for simultaneously measuring 3DOF LGEs by a laser, which comprises the following steps:

Step 1: measure a straightness error along Y-axis and/or Z-axis based on laser collimation principle

Step 1.1) when the emergent light L1 of a single frequency laser 1 hits on or passes through the polarizing beam splitter 2, it is divided into a measuring light L11 and a reference light L12, in which the measuring light L11 is reflected by the polarizing beam splitter 2, while the reference light L12 is transmitted through the polarizing beam splitter 2, and the measuring light L11 and the reference light L12 are both a linearly polarized light, and polarization directions of the two lights are perpendicular to each other;

Step 1.2) the measuring light L11 hits on or passes through the second quarter-wave plate 5, the linearly polarized light is changed into a circularly polarized light, which is emitted from the measuring unit I and incident on the target mirror unit II; after being reflected back 180° toward its original direction by the pyramid prism 9 of the target mirror unit II, a spatial position of the light L11 changes with a straightness error of the target mirror unit II along Y-axis and/or Z-axis; the light L11 carries the two-dimensional straightness error information back to the measuring unit I, and after hitting on or passing through the second quarter-wave plate 5 again, the light L11 changes from a circularly polarized light to a linearly polarized light, but a polarization direction after hitting on or passing through the second quarter-wave plate 5 again is rotated by 90°, so that the light L11 is transmitted through the polarizing beam splitter 2 when meeting it again;

Step 1.3) the reference light L12 hits on or passes through the first quarter-wave plate 4, then the linearly polarized light is changed into a circularly polarized light, which is reflected back 180° toward its original direction by a fixed pyramid prism 3; and after hitting on or passing through the first quarter-wave plate 4 again, it changes from the circularly polarized light to a linearly polarized light, but a polarization direction after hitting on or passing through the first quarter-wave plate 4 again is rotated by 90° with respect to that hitting on or passing through the polarizing beam splitter 2 before, so that the light L12 becomes reflected by the polarizing beam splitter 2, and is combined with the light L11 transmitted through the polarizing beam splitter in Step 1.2, to form the light L3; the light L3 is divided into lights L31 and L32 after transmitting through a first polarizer 6 and hitting on or passing through a first non-polarizing beam splitter 7, so as to be received by the first photodetector (A) and the second photodetector (B), respectively.

Steps 1.4 and 1.5 are the same as those in Embodiment 1, and will not be described in detail again.

Step 2: a position error along X-axis is measured based on the laser interference, which is consistent with Embodiment 1, and will not be described again in detail.

Similar to Embodiment 1, this Embodiment 2 can also use the single frequency laser with four channels in the interference length measuring module as shown in FIG. 3, so as to measure the position error along X-axis.

### Embodiment 3

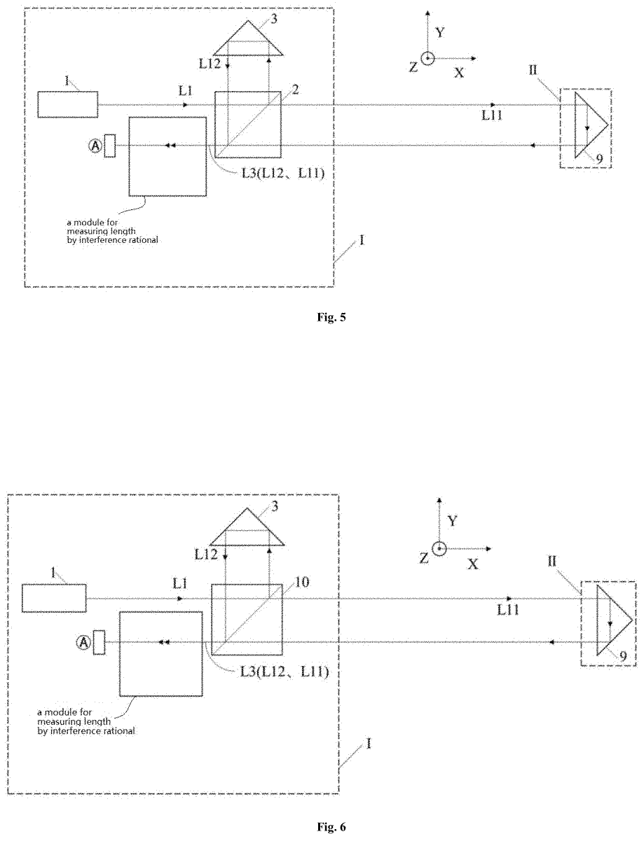

FIG. 5 is a view of a system for simultaneously measuring 3DOF LGEs by a single frequency laser. As shown in FIG. 5, in a further aspect of the present invention, there is provided a system for simultaneously measuring 3DOF LGEs by a single frequency laser. The system comprises a measuring unit I and a target mirror unit II.

The measuring unit I of this Embodiment 3 includes a single frequency laser 1, a polarizing beam splitter 2, a fixed pyramid prism 3, a first photodetector (A), and an interference length measuring module of the single frequency laser. The interference length measuring module adopts any one of the single frequency laser with dual channels in the interference length measuring module as shown in FIG. 2 and the single frequency laser with four channels in the interference length measuring module as shown in FIG. 3. Compared with the Embodiment 1, the first embodiment quarter-wave plate 4 and the second quarter-wave plate 5 are omitted; the light L11 is still transmitted when returning to the polarizing beam splitter 2, and the light L2 is still reflected when returning to the polarizing beam splitter 2. Compared with the Embodiment 1, an emitting direction of a combined beam L3 is rotated by 90°, and locations of the interference length measuring module of the single frequency laser and the first photodetector (A) are changed accordingly.

The target mirror unit II includes a pyramid prism 9. The structure and function are the same as those of the Embodiment 1, and will not be described again in detail.

In the measuring unit I,

the polarizing beam splitter 2 is used for: 1) beam splitting: an emergent light L1 is divided into a transmitted light recorded as a measuring light L11 and a reflected light recorded as a reference light L12, the measuring light L11 is hitting on or passing through the target mirror unit II, is reflected back by the pyramid prism 9 of the target mirror unit II, and returns to the measuring unit I with a 3DOF LGEs signal, while the reference light L12 only propagates within the measuring unit I; and 2) beam combining: the reference light L12 that hits on or passes through the polarizing beam splitter 2 again is reflected, while the measuring light L11 that is reflected back by the target mirror unit II is transmitted, so that the two beams of lights are superposed with each other in a spatial position, to form a combined light L3.

The functions of other components are the same as those in Embodiment 1, and will not be described again in detail.

Based on a single frequency laser with dual channels in the interference length measuring module, Embodiment 3 provides a method for simultaneously measuring 3DOF LGEs by a laser, which includes the following steps:

Step 1: measure a straightness error along Y-axis and/or Z-axis based on laser collimation principle

Step 1.1) being consistent with Embodiment 1, this step will not be described again in detail;

Step 1.2) a measuring light L11 exits from the measuring unit I and hits on or passes through the target mirror unit after being reflected back 180° toward its original direction by a pyramid prism 9 of the target mirror unit II, a spatial position of the light L11 changes with a straightness error of the target mirror unit II along Y-axis and/or Z-axis; the light L11 carries two-dimensional straightness error information back to the measuring unit I, and the light L11 is then transmitted through the polarizing beam splitter 2;

Step 1.3) the reference light L12 is reflected back 180° toward its original direction by a fixed pyramid prism 3, then is reflected by the polarizing beam splitter 2 when hitting on or passing through the same again; the light L12 is combined with the light L11 transmitted through the polarizing beam splitter 2 in Step 1.2, so as to form a combined light L3; after passing through a first polarizer 6 and hitting on or passing through a first non-polarizing beam splitter 7, the light L3 is divided into the lights L31 and L32, and is received by the first photodetector (A).

Steps 1.4 and 1.5 are the same as those in Embodiment 1, and will not be described again in detail.

Step 2: a position error along X-axis is measured based on the laser interference, which is consistent with Embodiment 1 and will not be described again in detail.

Based on the single frequency laser with four channels in the interference length measuring module, the method for simultaneously measuring 3DOF LGEs by a laser in Embodiment 3 is similar to the above methods, with the following differences: 1) a straightness error of the target mirror unit II along Y-axis and/or Z-axis can be calculated by a spot offset on any one of the first photodetector (A), the second photodetector (B), the third photodetector (C), and the fourth photodetector (D); 2) the phases of the light intensities I₁, I₂, I₄ and I₅ of the four detectors differ by 90° between any two in turn; by processing I₁, I₂, I₄ and I₅, there is determined N(Δx), a number of light and dark changes of interference fringes caused by φ(Δx), an emitting laser wavelength of the single frequency laser 1 is λ, a displacement of the target mirror unit II along X-axis is Δx=N(Δx)·λ/2, at the same time, a moving direction of the target mirror unit can be judged.

### Embodiment 4

FIG. 6 is a view of a system for simultaneously measuring 3DOF LGEs by a dual frequency laser according to Embodiment 4 of the present invention. Its overall structure is similar to FIG. 5, except that the second non-polarizing beam splitter 10 replaces the polarizing beam splitter 2, and a combined beam L3 comprises a reflected part of the reference beam L12 hitting on or passing through the second non-polarizing beam splitter 10 again and a transmitted part of the measurement beam L11 hitting on or passing through the second non-polarizing beam splitter 10 again.

Further, in the combined beam L3 of Embodiment 4, there is a transmitted part of the reference light L12 when passings through the second non-polarizing beam splitter 10 again, and a reflected part of the measuring light L11 hitting on or passing through the second non-polarizing beam splitter 10 again. The interference length measuring module of the single frequency laser is arranged in the emitting direction of the combined beam L3.

Further, Embodiment 4 adopts a reflection sensitive structure.

Further, the interference length measuring module of the single frequency laser of Embodiment 4 can also adopt the interference length measuring module of the single frequency laser with four channels as shown in FIG. 3.

### Embodiment 5

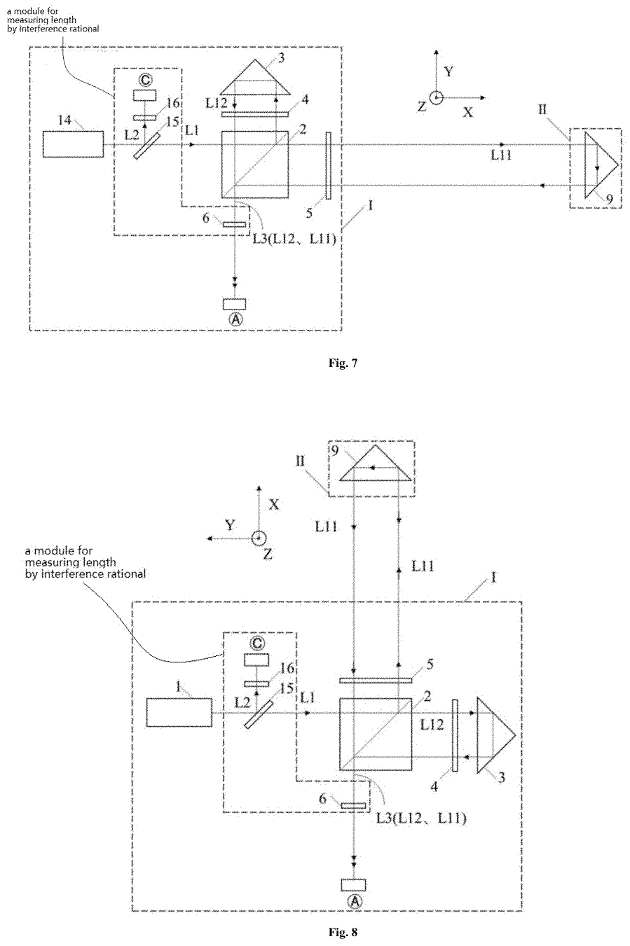

FIG. 7 is a view of a system for simultaneously measuring 3DOF LGEs by a dual frequency laser according to Embodiment 5 of the present invention. As shown in FIG. 7, according to the other aspect of the present invention, there is provided a system for simultaneously measuring 3DOF LGEs by a dual frequency laser, comprising a measuring unit I and a target mirror unit II.

The measuring unit I includes a dual frequency laser 14, a polarizing beam splitter 2, a fixed pyramid prism 3, and a first quarter-wave plate 4, a second quarter-wave plate 5, a first photodetector (A), a third photodetector (C) of a dual frequency interference length measuring module; the dual frequency laser 14 constitutes a laser emitting module; the interference length measuring module includes a first polarizer 6, a third non-polarizing beam splitter 15, a second polarizer 16, and a third photodetector (C).

The target mirror unit II includes a pyramid prism 9, which is consistent with Embodiment 1.

In the measuring unit I,

the dual frequency laser 14 is used to generate an emergent light L1, and the emergent light L1 is a polarized light superposed by two beams at a spatial position, the two beams has a certain frequency difference, and their polarization directions are perpendicular to each other;

the third non-polarizing beam splitter 15 is arranged between the dual frequency laser 14 and the polarizing beam splitter 2; the emergent light L1 is split by the third non-polarizing beam splitter 15, not only remaining in the original direction, but also having a reflected light denoted as L2;

the second polarizer 16 is arranged between the third non-polarizing beam splitter 15 and the third photodetector (C); the polarizing axis direction of the second polarizer 16 can be adjusted; the reflected light L2 interferes after hitting on or passing through the second polarizer 16, and an interference spot is received by the third photodetector (C) as a reference signal for heterodyne interference length measurement;

the combined beam L3 interferes after hitting on or passing through the first polarizer 6, and an interference spot is received by the first photodetector (A) as a measuring signal of heterodyne interference length measurement; according to the reference signal and the measurement signal, a displacement of the target mirror unit along X-axis can be calculated;

the third photodetector (C) is used to receive an interference spot of the light L2 as a standard signal for heterodyne interference length measurement;

the functions of the polarizing beam splitter 2, the fixed pyramid prism 3, the first quarter-wave plate 4, the second quarter-wave plate 5, the first polarizer 6, and the first photodetector (A) are the same as those of Embodiment 1, and will not be described again in detail.

The present Embodiment 5 provides a method for simultaneously measuring 3DOF LGEs by a dual frequency laser, which comprises the following steps:

Step 1: measuring a straightness error along Y-axis and/or Z-axis based on laser collimation principle, which is consistent with Embodiment 1, and will not be described again in detail;

Step 2: measuring a position error along X-axis based on laser interference

Step 2.1) in the light L1, the two polarized lights with a certain frequency difference have the frequencies f₁ and f₂, respectively, and when the light L1 is separated by the polarizing beam splitter 2, the frequency of the measuring light L11 is f₁, while the frequency of the reference light L12 is f₂;

Step 2.2) a displacement of the target mirror unit of the measuring light L11 along X-axis is Δx, a frequency variation due to Doppler effect is f(Δx), so that the frequency of the measuring light L11 is f₁+f(Δx);

Step 2.3) setting a first polarizer 6 in front of the first photodetector (A) and adjusting a direction of a light transmitting axis of the first polarizer 6, so that a combined light L3 (including the light L12 and the light L11) interferes after hitting on or passing through the first polarizer 6; the interference spot is received by the first photodetector (A) as a measuring signal of the heterodyne interference length measurement; a beat signal is measured to have a frequency fₘ=f₁+f(Δx)−f₂;

Step 2.4) when the emergent light L1 hits on or passes through the third non-polarizing beam splitter 15, another laser beam L2 is formed in a reflected direction of the third non-polarizing beam splitter 15; the light L2 also contains two polarized lights with a certain frequency difference; the polarizing axis direction of the second polarizer 16 is adjusted, so that the two polarized lights with a certain frequency difference in the light L2 interfere with each other; the interference spot is received by the third photodetector (C) as a standard signal for the heterodyne interference length measurement, then the standard signal frequency is fₛ=f₁−f₂;

Step 2.5): the frequency of the beat signal measured in Step 2.3, fₘ=f₁+f(Δx)−f₂, subtracts the standard beat signal frequency obtained in Step 2.4, fₛ=f₁−f₂, so as to obtain f(Δx)=fₘ−fₛ, a number of light and dark changes of interference fringes caused by f(Δx) is N(Δx), a laser wavelength emitting from a laser is λ, so a displacement of the target mirror unit along X-axis is Δx=N(Δx)·λ/2.

Further, this Embodiment 5 can adopt a reflection sensitive structure as shown in FIG. 8.

Further, in this Embodiment 5, on the basis of adopting the transmission sensitive structure, the first quarter-wave plate 4 and the second quarter-wave plate 5 are omitted; the light L11 after returning to the polarizing beam splitter 2 is still transmitted, while the light L2 after returning to the polarizing beam splitter 2 is still reflected. Compared with FIG. 7, an emitting direction of the combined beam L3 is rotated by 90°, and locations of the first polarizer 6 and the first photodetector (A) are changed accordingly, as shown in FIG. 9.

Further, in this Embodiment 5, on the basis of adopting the reflection sensitive structure, the first quarter-wave plate 4 and the second quarter-wave plate 5 are omitted, the light L11 after returning to the polarizing beam splitter 2 is still transmitted, while the light L2 after returning to the polarizing beam splitter 2 is still reflected. Compared with FIG. 8, an emitting direction of the combined beam L3 is rotated by 90°, and locations of the first polarizer 6 and the first photodetector (A) are changed accordingly.

### Embodiment 6

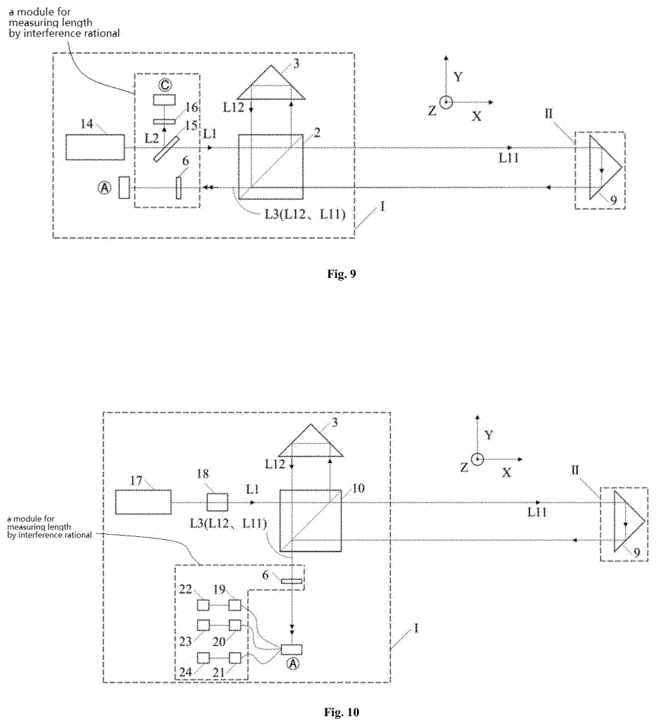

FIG. 10 shows a system for simultaneously measuring 3DOF LGEs by a multi wavelength laser according to Embodiment 6 of the present invention. As shown in FIG. 10, according to another aspect of the present invention, a system for simultaneously measuring 3DOF LGEs by a multi wavelength laser is provided to comprise a measuring unit I and a target mirror unit II.

The measuring unit I includes a multi wavelength laser light source 17, a heterodyne frequency generating unit 18, a second non-polarizing beam splitter 10, a fixed pyramid prism 3, a first polarizer 6, a first photodetector (A), a first bandpass filter 19, a second bandpass filter 20, a third bandpass filter 21, a first phase detector 22, a second phase detector 23, and a third phase detector 24.

The multi wavelength laser light source 17 and the heterodyne frequency generating unit 18 constitute a laser emitting module. The first polarizer 6, the first bandpass filter 19, the second bandpass filter 20, the third bandpass filter 21, the first phase detector 22, the second phase detector 23, and the third phase detector 24 constitute an interference length measuring module.

The target mirror unit II includes a pyramid prism 9, which is consistent with Embodiment 1.

In the measuring unit I,

the multi wavelength laser light source 17 is used to generate the emergent light L1, and the emergent light L1 includes multi wavelength lasers λ₁, λ₂, λ₃, and their frequencies are v₁, v₂, v₃;

the heterodyne frequency generating unit 18 is used to change the frequencies of the emergent light L1 to v₁+f₁, v₂+f₂, v₃+f₃;

the second non-polarizing beam splitter 10 is used for:

1) beam splitting: the emergent light L1 is divided into a measuring light L11 and a reference light L12, the measuring light L11 is hitting on or passing through the target mirror unit II and is reflected back by the target mirror unit II, and then returns to the measuring unit I with a 3DOF LGEs signal; while the reference light L12 only propagates inside the measuring unit;

2) beam combining: a transmitted part of the reference light L12 hitting on or passing through the second non-polarizing beam splitter 10 again, and a reflected part of the measuring light L11 hitting on or passing through the second non-polarizing beam splitter 10 again, are superposed with each other in a spatial position, to form a combined light L3.

The first photodetector (A) is used to receive the combined light L3 to realize: 1) calculating a straightness error of the target mirror unit II along Y-axis and/or Z-axis according to a spot offset of the light L11 on the first photodetector (A); 2) coordinating with the interference length measuring module to measure a position error of the target mirror unit II along X-axis.

A low frequency response spectrum of the first photodetector (A) cannot be used to test a much higher optical frequency (a much higher frequency signal is divided into a few low frequency signals which become to be detected by photodetectors and to mathematically form the much higher frequency signal); and the measured heterodyne interference signal spectrum of the combined light L3 contains only f₁, f₂, f₃, etc.; the first to third band-pass filters of the interference length measuring module separate the f₁, f₂, f₃ of the first photodetector (A), to measure the length measuring phase information φ₁, φ₂, φ₃ corresponding to each wavelength by the first to third phase detectors; taking two pairs of beat signals, and calculating a displacement Δx of the target mirror unit along X-axis according to two pairs of wavelength and two pairs of phase difference.

The present Embodiment 6 provides a method for simultaneously measuring 3DOF LGEs by a laser, which comprises the following steps:

Step 1: measure a straightness error along Y-axis and/or Z-axis based on laser collimation principle

A multi wavelength laser light source 17 is used, an emergent light L1 includes multi wavelength lasers λ₁, λ₂, λ₃, however, when measuring a straightness error along Y-axis and/or Z-axis with the laser collimation principle, only the spot offset on the detector is detected, it is not different from the measurement with a single frequency laser, and it is consistent with Embodiment 1, so will not be described again in detail;

Step 2: measure a position error along X-axis based on a multi wavelength laser interference

Step 2.1) the light L1 emitted from the multi wavelength laser light source 17 includes multi wavelength lasers λ₁, λ₂, λ₃, their frequencies are v₁, v₂, v₃; after hitting on or passing through the heterodyne frequency generating unit 18, the frequencies of the multi wavelength laser becomes v₁+f₁, v₂+f₂, v₃+f₃;

Step 2.2) the emergent light L1 is split into a measuring light L11 and a reference light L12 by the second non-polarizing beam splitter 10; both the measuring light L11 and the reference light L12 contain multi wavelength lasers v₂+f₂, v₃+f₃;

Step 2.3) the measuring light L11 is emitted from the measuring unit I, and once reaching the target mirror unit II, the measuring light L11 is reflected back by the target mirror unit II, returning to the half transmitting and half reflecting mirror 10 of the measuring unit I with a straightness error information along X-axis as a signal of a measuring light of the heterodyne interference length measurement;

Step 2.4) the reference light L12 is reflected back 180° toward its original direction by a fixed pyramid prism 3 of the measuring unit I, then a transmitted part after hitting on or passing through the non-polarizing beam splitter 12, and a reflection part of the light L11 turning on the non-polarizing beam splitter 12 is combined with each other, to form a combined light L3, and a polarizing axis direction of the first polarizer 6 is adjusted, so that the light L3 interferes on the first photodetector (A) after hitting on or passing through the first polarizer 6;

Step 2.5) the first photodetector (A) detects components such as f₁, f₂ and f₃ of the heterodyne interference signal spectrum, and the first to third band-pass filters 18-20 separate the components f₁, f₂ and f₃, and the first to third phase detectors 21-23 measure the length measuring phase information φ₁, φ₂, φ₃ corresponding to each wavelength; taking two pairs of beat signals, and calculating a displacement Δx of the target mirror unit II along X-axis according to the wavelengths and the phase difference;

There are three other structures in this Embodiment 6:

1) adopting a reflection sensitive structure;

2) with a transmission sensitive structure, a combined light L3′ is composed of a reflected part of the light L12 after hitting on or passing through the second non-polarizing beam splitter 10 for the second time and a transmitted part of the light L11 after hitting on or passing through the second non-polarizing beam splitter 12 again; and the first polarizer 6 and the first photodetector (A) are arranged in an emitting direction of the combined light L3′;

3) with a reflection sensitive structure, a combined light L3′ is composed of a reflected part of the light L12 after hitting on or passing through the second non-polarizing beam splitter 10 for the second time and a transmitted part of the light L11 after hitting on or passing through the second non-polarizing beam splitter 12 again; and the first polarizer 6 and the first photodetector (A) are arranged in an emitting direction of the combined light L3′.

To sum up, the system and method for simultaneously measuring 3DOF LGEs by a laser according to the embodiments of the present invention can be realized to perform simultaneous and rapid measurement of 3DOF LGEs of space objects moving linearly along any linear axis; and a longtime monitoring 3DOF linear position change of two objects in space.

Each embodiment in this specification describes a system and method for rapidly measuring 3DOF LGEs of a space object while the measuring unit I remains stationary and the target mirror unit II and the space object move linearly along a linear axis. After an optical path adjusting is completed, the systems in all embodiments will perform the following actions. 1) keeping the target mirror unit II stationary, and making the measuring unit I and the space object move linearly along a linear axis, it can also realize the simultaneous and rapid measurement of 3DOF LGEs of space objects; 2) by keeping the measuring unit I and the target mirror unit II stationary, and monitoring data measured by the measuring unit for a long time, a long-term monitoring 3DOF linear position drift of two objects in space can be realized.

In the case of a multi wavelength measurement, it is each single detector measurement. For single frequency and double frequency length measurement, at least one detector shall be equipped for auxiliary measurement. According to the present invention, the first photodetector (A) cooperates with different interference length measuring modules, and the target mirror and every single detector each has a single optical component, it is the first time in the world to realize simultaneously measuring three linearity errors (i.e., three linearity errors in X, Y and Z axis translation). Compared with prior art multi degree of freedom measurement systems and methods, it has the following beneficial effects: 1) simplifying an optical path structure, reducing complexity of the measurement system and volume of the measuring unit and the target mirror unit, and facilitating practical application; 2) reducing a number of detectors, so as to reduce circuit power consumption, reduce heat dissipation, improve stability of the measurement system, and reduce cost of the measurement system.

The invention can simultaneously measure the linear error of 3DOF, and greatly improves a measurement efficiency compared with the prior art single degree of freedom measurement system and method.

Those skilled in the art can understand that the drawings are only schematic views of embodiments, and some modules or processes in the drawings might be possibly not necessary at all to implement the present invention.

It can be seen from the description of the above embodiments that those skilled in the art can clearly understand that the present invention can be realized by means of software and necessary general hardware platform. Based on this understanding, the technical solution of the present invention can be embodied in software, which can be stored in a storage medium, such as ROM/RAM, magnetic disk, optical disk, etc., including several instructions for causing a computer equipment (which may be a personal computer, a server, or a network device, etc.) to perform the method described in each embodiment or some part of the embodiments of the present invention.

The embodiments in this specification are described in a progressive manner. The same and similar parts of each embodiment can be referred to each other. Each embodiment focuses on those differences from other embodiments. In particular, as for the apparatus or system embodiment, it is basically similar to the method embodiment, so their description is relatively simple. For relevant parts, please refer to the corresponding description of the method embodiment. The above described apparatus and system embodiments are only schematic, those units described as separate components may or may not be physically separated, and the components displayed as a unit may or may not be a physical unit, that is, they may be located in the same place or may be distributed on multiple network units. Some or all of the modules can be selected according to actual needs to achieve the purpose of the embodiment. Those skilled in the art can understand and implement it without creative work.

The above description is only to the preferred embodiments of the present invention, but the scope of protection of the present invention is not limited to this. Any change or alternative solution that can be easily derived by those skilled in the art within the spirit of the present invention shall be covered by the scope of protection of the present invention. Therefore, the scope of protection of the present invention should be determined by the appended claims.

1. A system for simultaneously measuring 3DOF LGEs by a laser, wherein it comprises a measuring unit and a target mirror unit, the measuring unit includes a laser emitting module, a polarizing beam splitter, a fixed reflector, a first photodetector and an interference length measuring module; the target mirror unit includes a reflector;
the laser emitting module is used to generate an emitting light L1,
the polarizing beam splitter is used for 1) “beam splitting”, which comprises splitting the emitting light L1 into a measuring light L11 and a reference light L12, the measuring light L11 is passing through or hitting on the target mirror unit, being reflected back by the target mirror unit, then returning to the measuring unit with a 3DOF LGEs signal, while the reference light L12 only propagates inside the measuring unit; and 2) “beam combining”, which comprises transmitting or reflecting the reference light L12 that hits on or passes through the polarizing beam splitter again and the measuring light L11 that is reflected back 180° toward its original direction by the target mirror unit according to their polarizing states, so that two beams of the measuring light L11 and the reference light L12 are superposed with each other in a spatial position, so as to form a combined light L3;
the fixed reflector is used for backward reflecting the reference light L12 propagating only inside the measuring unit, to return the reference light L12 to the polarizing beam splitter;
the first photodetector is used to receive the combined light L3 including the reference light L12 and the measuring light L11, so as to realize simultaneous measurement of LGEs along X, Y and Z axes; specifically, 1) according to a spot offset of the measuring light L11 on the first photodetector, a relative straightness error between the target mirror unit and the measuring unit along Y and/or Z axes is calculated; 2) cooperating with the interference length measuring module to measure a relative position error between the target mirror unit and the measuring unit along X-axis; and
the reflector in the target mirror unit is used to reflect the measuring light L11 backward, and return the measuring light L11 to the polarizing beam splitter to realize that 1) changing a spatial position of the measuring light L11 in Y and/or Z directions, and an amount of the spatial position offset in Y or Z direction is twice a relative displacement between the reflector of the target mirror unit and the measuring unit along Y or Z axis, respectively; 2) changing an optical path and frequency of the measuring light L11, in which an amount of change of the optical path and frequency is proportional to the relative displacement between the reflector of the target mirror unit and the measuring unit along X-axis.

2. The system according to claim 1, wherein when a single frequency laser measurement is applied, the laser emitting module emits a single frequency laser, and the interference length measuring module includes a first polarizer, a first non-polarizing beam splitter, a phase retarder, and a second photodetector;
the first polarizer is arranged in an emitting direction of the combined light L3, and a light transmitting axial direction of the first polarizer is adjusted, so that the reference light L12 and the measuring light L11 interfere with each other after the combined light L3 hits on or passes through the first polarizer;
the first non-polarizing beam splitter is arranged between the first polarizer and the first photodetector, and is used to split the combined beam L3 that has been interfered, in which one beam light L31 is received by the first photodetector, while the other beam light L32 is received by the second photodetector; light intensities of interference spots on the first photodetector and the second photodetector are l₁ and I₂, respectively; and
the phase retarder is arranged in front of the first photodetector or the second photodetector, and is used to make a phase difference 90° between the interference spot signals I₁ and I₂ detected by the two photodetectors, calculate a phase difference φ(Δx) between the reference light L12 and the measuring light L11, and calculate a relative displacement Δx between the target mirror unit and the measuring unit along X-axis according to the phase difference.

3. The system according to claim 1, wherein when a single frequency laser measurement is applied, the laser emitting module emits a single frequency laser, the polarizing beam splitter is replaced with a second non-polarizing beam splitter; the interference length measuring module includes a first polarizer, a first non-polarizing beam splitter, a phase retarder, and a second photodetector;
the second non-polarizing beam splitter is used to perform 1) “beam splitting” comprising splitting the emitting light L1 into a measuring light L11 and a reference light L12, the measuring light L11 is hitting on or passing through the target mirror unit, being reflected back by the target mirror unit, and returning to the measuring unit with a 3DOF LGEs signal, while the reference light L12 only propagates inside the measuring unit; and 2) “beam combining” comprising transmitting or reflecting the reference light L12 that hits on or passes through the non-polarizing beam splitter again and the measuring light L11 reflected by the target mirror unit, so that the above two beams are superposed with each other in a spatial position, so as to form a combined beam L3; the combined beam L3 is a superimposed beam of a beam of the reference light L12 transmitted through the non-polarizing beam splitter and a beam of the measuring light L11 reflected by the non-polarizing beam splitter, or a superimposed beam of a beam of the reference light L12 reflected by the non-polarizing beam splitter and a beam of the measuring light L11 transmitted through the non-polarizing beam splitter;
the first polarizer is arranged in an emitting direction of the combined light L3, and a light transmitting axial direction of the first polarizer is adjusted, so that the reference light L12 and the measuring light L11 interfere with each other after the combined light L3 hits on or passes through the first polarizer;
the first non-polarizing beam splitter is arranged between the second non-polarizing beam splitter and the first photodetector, and is used to split the combined beam L3 that has been interfered, in which one beam L31 is received by the first photodetector, while the other beam L32 is received by the second photodetector; light intensities of interference spots on the first photodetector and the second photodetector are I₁ and I₂, respectively; and
the phase retarder is arranged in front of the first photodetector or the second photodetector, and is used to make a phase difference 90° between interference spot signals I₁, I₂ detected by the above two photodetectors, and calculate a phase difference φ(Δx) between the reference light L12 and the measuring light L11, and calculate a relative displacement Δx between the target mirror unit and the measuring unit along X-axis according to the phase difference.

4. The system according to claim 1, wherein when a dual frequency laser measurement is applied, the laser emitting module emits a dual frequency laser light, whose two frequencies are with a certain frequency difference and different polarization directions;
the interference length measuring module comprises a third non-polarizing beam splitter, a first polarization detector, a second polarization detector, and a third photodetector;
the third non-polarizing beam splitter is disposed between the laser emitting module and the polarizing beam splitter, so that the light L1 emitted from the laser emitting module is split by the third non-polarizing beam splitter to form another laser beam L2;
the first polarizer is arranged in an emitting direction of the combined light with the reference light L12 and the measuring light L11 reflected by the target mirror unit to hit on or pass through the polarizing beam splitter; and a light transmitting axial direction of the first polarizer is adjusted, so that the combined light L3 with the light L12 and the light L11 hits on or passes through the first polarizer, the reference light L12 and the measuring light L11 interfere with each other, and an interference spot is received by the first photodetector as a measuring signal for heterodyne interferometry;
the second polarizer is arranged between the third non-polarizing beam splitter and the third photodetector; a light transmitting axial direction of the second polarizer is adjusted, so that after the laser light L2 hits on or passes through the second polarizer, the light L2 interferes, and an interference spot is received by the third photodetector as a reference signal for heterodyne interference length measurement; and
a relative displacement between the target mirror unit and the measuring unit along X-axis is calculated according to the reference signal and the measuring signal.

5. The system according to claim 1, wherein when a multi wavelength measurement is applied, the laser emitting module comprises a multi wavelength laser light source and a heterodyne frequency generating module, the interference length measuring module comprises the 1st to the Nth band-pass filters and the 1st to the Nth phase detectors, N is a natural number greater than or equal to 3, and the polarizing beam splitter is replaced with a second non-polarizing beam splitter;
the multi wavelength laser light source emits multi wavelength laser lights λ₁, λ₂, λ₃, . . . , λ_{N}, their frequencies are v₁, v₂, v₃, . . . , v_{N}; after hitting on or passing through the heterodyne frequency generating module, the frequencies of the multi wavelength laser becomes v₁+f₁, v₂+f₂, v₃+f₃, v_{N}+f_{N}; the multi wavelength laser light is the emitting light L1, the second non-polarizing beam splitter is used to perform 1) “beam splitting” comprising splitting the emitting light L1 into a measuring light L11 and a reference light L12, the measuring light L11 is hitting on or passing through the target mirror unit and is reflected back by the target mirror unit; the light L11 carries a 3DOF LGEs signal and returns to the measuring unit as a measuring light, while the reference light L12 only propagates within the measuring unit; and 2) “beam combining” comprising transmitting or reflecting the reference light L12 that hits on or passes through the second non-polarizing beam splitter again and the measuring light L11 reflected by the target mirror unit, so that the above two beams are superposed with each other in a spatial position, so as to form a combined beam L3;
the light L3 interferes on the first photodetector, and the obtained heterodyne interference signal spectrum only contains components f₁, f₂, f₃, . . . , f_{N}; and
after the 1st to the Nth bandpass filters separate the components f₁, f₂, f₃, f_{N}, the length measuring phase information φ₁, φ₂, φ₃, . . . , φ_{N} corresponding to each wavelength is measured by the 1st to the Nth phase detectors; taking n (2≤n≤N−1, n is a natural number) pairs to form a beat signal, and a relative displacement Δx between the target mirror unit and the measuring unit along X-axis is calculated according to n pairs of wavelength and n pairs of phase difference.

6. The system according to claim 1, wherein the fixed reflector is any one of a pyramid prism, a cat's eye mirror, an angular cube retroreflector composed of three mutually perpendicular reflecting surfaces, a right angle prism, and a mirror set composed of two planar mirrors; and the target mirror unit reflector is anyone of a pyramid prism, a cat's eye mirror, and an angular cube retroreflectors composed of three mutually perpendicular reflecting surfaces.

7. The system according to claim 1, wherein the first photodetector, the second photodetector, the fourth photodetector, and the fifth photodetector are anyone of QD, PSD, CCD, and CMOS; a relative straightness error between the target mirror unit and the measuring unit along Y-axis and/or Z-axis is calculated according to a spot offset on anyone of the four photodetectors; and the third photodetector is anyone of QD, PSD, CCD, CMOS, and pin.

8. A method for simultaneously measuring 3DOF LGEs by a laser, comprising:
Step 1) measuring a straightness error along Y-axis and/or Z-axis based on laser collimation principle Step 1.1) a light L1 emitted from a laser emitting module hits on or passes through a polarizing beam splitter, then the light L1 is divided into a measuring light L11 and a reference light L12;
Step 1.2) the measuring light L11 is emitted from the measuring unit, is incident on the target mirror unit, and is reflected back 180° toward its original direction by a reflector of a target mirror unit; a spatial position of the light L11 drifts with a relative straightness error between the target mirror unit and a measuring unit along Y-axis and/or Z-axis; the light L11 carries two-dimensional straightness error information back to the measuring unit, and the light L11 hits on or passes through the polarizing beam splitter again;
Step 1.3) the reference light L12 is reflected back 180° toward its original direction by a fixed reflector, reaching the polarizing beam splitter again, and is combined with the light L11 reflected by the polarizing beam splitter again in Step 1.2, so as to form a light L3 which is received by a first photodetector;
Step 1.4) an initial position of the combined beam spot is measured by the first photodetector;
Step 1.5) a real-time position of a combined beam spot on the first photodetector is obtained, so as to obtain a combined beam spot offset compared with the initial position of the combined beam spot; the combined beam spot offset is only caused by a position offset of the measuring light L11, and a relative straightness error between the target mirror unit and the measuring unit along Y-axis and/or Z-axis is calculated according to the combined beam spot offset;
Step 2) measuring a position error along X-axis based on laser interference
Step 2.1) the reference light L12 in Step 1.1 is reflected back 180° toward its original direction by the fixed reflector of the measuring unit, its polarization state, frequency and phase are not changed, so the light L12 is used as a reference light of the interference length measurement signal;
Step 2.2) a frequency and phase of the light L11 in Step 1.2 drift with a relative displacement between the target mirror unit and the measuring unit along X-axis, and the light L11 carries a relative straightness error information along X-axis and returns to the measuring unit as a measuring light of a heterodyne interference length measuring signal; and
Step 2.3) the reference light in Step 2.1 and the measuring light in Step 2.2 hit on or pass through the polarizing beam splitter, the two beams are superposed with each other in a spatial position; after hitting on or passing through the polarizing beam splitter of an interference length measuring module, a relative straightness error between the target mirror unit and the measuring unit along X-axis is calculated with the signal measured on the first photodetector.

9. The method according to claim 8, wherein calculating a relative straightness error along Y-axis and/or Z-axis according to the spot offset of the combined light comprises:
if an initial position and a real-time position of a spot of the light L11 on the first photodetector are (y10, z10), (y1ₜ, z1ₜ), respectively, then relative straightness errors between the target mirror unit and the measuring unit along Y-axis and/or Z-axis are Δy=2(y1ₜ−y1ₒ), Δz=2(z1ₜ−z1ₒ), respectively.

10. The method according to claim 8, wherein when a single frequency laser measurement is applied, a position error of length measurement along X-axis based on a laser interferometry comprises:
Step 1) the reference light L12 and the measuring light L11 are superposed with each other in a spatial position after hitting on or passing through the polarizing beam splitter or the second non-polarizing beam splitter, to form the combined light L3, and a light transmitting axial direction of the first polarizer is adjusted, so that the combined light L3 interferes after hitting on or passing through the first polarizer;
Step 2) the interference light L3 is divided into lights L31 and L32 after hitting on or passing through the first non-polarizing beam splitter;
Step 3) one of the lights L31 and L32 is delayed 90° by a phase retarder, then they are received by the first photodetector and the second photodetector, respectively, and light intensities of interference spots on the first photodetector and the second photodetector are l₁, I₂, respectively; and
Step 4) with the light intensities l₁, I₂, a phase difference between the reference light L12 and the measuring light L11 is φ(Δx), a number of light and dark changes of interference fringes caused by φ(Δx) is N(Δx), a laser wavelength emitting from a laser is λ, a relative displacement between the target mirror unit and the measuring unit along X-axis is Δx=N(Δx)·λ/2.

11. The method according to claim 8, wherein when a double frequency laser measurement is applied, a position error of length measurement along X-axis based on laser interference measurement comprises:
Step 1) in the light L1 emitted from the laser emitting module, two polarized lights with a certain frequency difference have frequencies f₁, f₂, respectively, and when the light L1 is split by the polarizing beam splitter, a frequency of the measuring light L11 is f₁, while a frequency of the reference light L12 is f₂;
Step 2) a relative displacement of the measuring light L11 between the target mirror unit and the measuring unit along X-axis is Δx, a frequency variation due to Doppler effect is f(Δx), and a frequency of the measuring light L11 is f₁+f(Δx),
Step 3) setting a first polarizer in front of the first photodetector, adjusting a direction of the light transmitting axis of the first polarizer, so that the light L12 and the light L11 interfere after hitting on or passing through the first polarizer, and an interference spot is received by the first photodetector as a measuring signal of heterodyne interference length measurement, and a frequency for measuring a beat signal is f₁+f(Δx)−f₂,
Step 4) when the emitting light L1 hits on or passes through the third non-polarizing beam splitter, it is split by the third non-polarizing beam splitter to form another laser beam L2; the light L2 also contains two polarized lights with a certain frequency difference, and a light transmitting axial direction of the second polarizer is adjusted, so that the light L2 interferes after hitting on or passing through the second polarizer; an interference spot is received by a second photodetector as a standard signal for heterodyne interference length measurement, then a standard signal frequency is fₛ=f₁−f₂; and
Step 5) the frequency of the beat signal measured in step 3), fₘ=f₁+f(Δx)−f₂, minus the standard beat signal frequency, fₛ=f₁−f₂, obtained in step 4), so as to obtain f(Δx)=fₘ−fₛ, a number of light and dark changes of interference fringes caused by f(Δx) is N(Δx), a laser wavelength emitting from a laser is λ, and a relative displacement between the target mirror unit and the measuring unit along X-axis is Δx=N(Δx)·λ/2.

12. The method according to claim 8, wherein when a multiple wavelength laser or laser measurement is applied, measuring a position error along X-axis based on laser interference comprises:
Step 1) a multi wavelength laser light source emits multi wavelength laser lights λ₁, λ₂, λ₃, . . . , A_{N}, their frequencies are v₁, v₂, v₃, . . . , v_{N}; after transmitting through the heterodyne frequency generating module, frequencies of the multi wavelength laser become v₁+f₁, v₂+f₂, v₃+f₃, v_{N}+f_{N}, the multi wavelength laser light is the emitting light L1;
Step 2) the light L1 emitted from the laser emitting module is divided into the measuring light L11 and the reference light L12 by the second non-polarizing beam splitter; the measuring light L11 and the reference light L12 both contain multi wavelength laser lights v₁+f₁, v₂+f₂, v₃+f₃, v_{N}+f_{N};
Step 3) the measuring light L11 is emitted from the measuring unit to hit on or pass through the target mirror unit, and the light L11 is reflected back 180° toward its original direction by the reflector of the target mirror unit; and the light L11 carries straightness error information along X-axis, and returns to the measuring unit as the measuring light of a heterodyne interference length measuring signal;
Step 4) after the reference light L12 is reflected back 180° toward its original direction by a fixed reflector of the measuring unit, it hits on or passes through the non-polarizing beam splitter, and then combines with the light L11, and by adjusting a light transmitting axial direction of the first polarizer, the reference light L12 and the measuring light L11 interfere with each other on the first photodetector; and
Step 5) the first photodetector detects components f₁, f₂, f₃, . . . , f_{N} of heterodyne interference signal spectrum; the 1st to the Nth band-pass filters separate the components f₁, f₂, f₃, . . . , f_{N}, and the 1st to the Nth phase detectors measure length measuring phase information φ₁, φ₂, φ₃, . . . , φ_{N} corresponding to each wavelength; there is n pairs of the beat signal, n is a natural number, and a relative displacement Δx between the target mirror unit and the measuring unit along X-axis is calculated according to n pairs of wavelength and n pairs of phase difference.
